(19) United States
(12) Patent Application Publication
(10) Pub. No.: US 2003/0048933 A1
(43) Pub. Date: Mar. 13, 2003

(54) Time-delay integration imaging of biological specimen

(76) Inventors: Carl S. Brown, Seattle, WA (US); Joseph J. Victor, Bellevua, WA (US)

Correspondence Address: Pillsbury Winthrop LLP, Intellectual Property Group, Suite 200, 11682 EI Camino Real, San Diego, CA, 92130, US

(21) Appl. No.: 10/215,265

(22) Filed: Aug. 6, 2002

Related U.S. Application Data
(60) Provisional application No. 60/311,060, filed on Aug. 8, 2001.

(51) Int. Cl. G01N 21/64

(52) U.S. Cl. 382/128; 382/129; 250/461.2

(57) ABSTRACT

A biological sample is scanned with Time-Delay Integration (TDI) by a CCD camera having columns and rows. When the light from a location of the sample falls onto a picture element (pixel) on the camera, the photons of the light are converted to electrons. The electrons within that pixel are shifted down one row to the pixel directly beneath it. The shifts occur in the columnar direction of the camera while the sample is moved synchronously with the electrons. The electrons shifted off the bottom row of the camera are measured and converted into a digital value for that picture element in the sample image.

### CROSS-REFERENCE TO RELATED APPLICATIONS

This application claims benefit of U.S. Provisional Application No. 60/311,060, filed Aug. 8, 2001. The aforementioned application is explicitly incorporated herein by reference in its entirety and for all purposes.

### TECHNICAL FIELD

This invention relates generally to imaging biological specimens in low light conditions, and more specifically concerns fluorescence imaging of biological specimens using time-delay integration techniques.

### BACKGROUND

Biomedical research has made rapid progress based on sequential processing of biological samples. Sequential processing techniques have resulted in important discoveries in a variety of biologically related fields, including, among others, genetics, biochemistry, immunology and enzymology. Historically, sequential processing involved the study of one or two biologically relevant molecules at the same time. These original sequential processing methods, however, were quite slow and tedious. Study of the required number of samples (up to tens of thousands) was time consuming and costly.

A breakthrough in the sequential processing of biological specimens occurred with the development of techniques of parallel processing of the biological specimens, using fluorescent marking. A plurality of samples are arranged in arrays, referred to herein as microarrays, of rows and columns into a field, on a substrate slide or similar member. The specimens on the slide are then biochemically processed in parallel. The specimen molecules are fluorescently marked as a result of interaction between the specimen molecule and other biological material. Such techniques enable the processing of a large number of specimens very quickly.

A significant challenge exists in the imaging of the microarrays of biological specimens. To produce imaging results of high quality, sufficient signal intensity is generally required. However, signal intensity is typically limited by the nature of the specimens, illumination intensity, or physical limits of indicators used in conjunction with the specimens. Signal intensity may be especially limited when fluorescently labeled biological specimens are imaged. When imaging the specimens, all of the three limitations (sample, illumination, and indicator) are prevalent. Therefore, image quality of the specimens may be adversely affected.

### SUMMARY

A biological sample is scanned with Time-Delay Integration (TDI) by a CCD camera having columns and rows. The sample is imaged continuously by the CCD camera as the sample is moving in the columnar direction of the camera. When the light from a location of the sample falls onto a picture element (pixel) on the camera, the photons of the light are converted to electrons. The electrons within that pixel are shifted down one row to the pixel directly beneath it. The shifts occur in the columnar direction of the camera while the sample is moved synchronously with the electrons. Those electrons are moved such that the sample follows the electrons accumulating for that portion of the sample while moving down the entire column of the camera. At the bottom of the column, the sample moves beyond the field of view of the camera as the electrons are shifted off the bottom row of the camera. As the electrons are shifted off, the electrons are measured and converted into a digital value for that picture element in the sample image as the electrons would with a normal full-frame CCD camera.

TDI allows for longer exposure per pixel for a given total image collection time. Therefore, TDI may be used in the imaging of objects where signal intensity is limited, such as in fluorescence imaging.

In one aspect of the invention, the invention relates to a method for imaging biological specimens using an imaging chip having rows and columns. The method includes capturing a pixel image of an object on the specimens; shifting the pixel image in the columnar direction of the imaging chip; moving the object in synchronous motion with the pixel image; and reading out voltage values from the bottom row of the imaging chip until a plurality of the specimens are imaged.

Embodiments of this aspect of the invention may include one or more of the following features. The voltage values may be read out from the bottom row of the imaging chip until all of the specimens are imaged. The biological specimens may be immobilized on a microarray. The biological specimen may comprise a nucleic acid or a polypeptide. The method may also comprise digitizing the voltage values to produce a digital image strip. The method may also comprise imaging other strips by changing an imaged area on the specimens; and joining together all the strips to form a final image. In certain embodiments of this aspect of the invention, the digital image strip is a final image captured by a single wide optical detector.

The method may further comprise: adjusting exposure time of the image pixel by adjusting read out speed of the imaging chip. The method may comprise adjusting exposure time of the image pixel by adjusting scan rate of the imaging chip. In certain embodiments of this aspect of the invention, the object may be moved at a constant speed. The object may be held for exposure and moved, one row at a time, down the imaging chip at the end of the exposure.

The method may further comprise: measuring calibration data; determining positional and rotational errors from the calibration data; and modifying the position of an image area based on the errors.

The method may also comprise: labeling the specimens with multiple indicators that respond to light of different wavelengths; choosing a filter pair for a selected wavelength; imaging the specimens with a single monochromatic detector through the filters to produce a component scan; repeating the component scans for each of the wavelengths; and combining the component scans to produce a multi-spectral image. For each of the component scans, actual velocities and positions of the specimens may be measured.

The method may further comprise: labeling the specimens with multiple indicators that respond to light of different wavelengths; and simultaneously scanning the specimens with multiple monochromatic detectors. The method may further comprise: labeling the specimens with multiple indicators that respond to light of different wavelengths; and simultaneously scanning the specimens with a single monochromatic detector masked with a color mask.

In another aspect of the invention, the invention relates to a method for imaging a sample using an imaging device. The method includes: moving the position of an image area on the sample along one dimension of the device; imaging a spot on the image area continuously until the imaged spot is moved out of the detection range of the device; and adjusting the speed of the movement for adequate exposure time.

Embodiments of this aspect of the invention may include one or more of the following features. The sample may comprise a fluorescently labeled biological sample. The sample may comprise a microarray. The sample may also comprises a plurality of nucleic acids or polypeptides immobilized to a surface. The imaging device may be a CCD camera with columns and rows. The image area may be moved along the column dimension of the CCD camera. The spot may be held for exposure and moved, one row at a time, down the CCD camera at the end of the exposure.

The method may further comprise: adjusting the exposure time of the image area by adjusting read out speed of the imaging device. The exposure time of the image area may also be adjusted by adjusting scan rate of the imaging device.

In certain embodiments of this aspect of the invention, the method may further comprise: measuring calibration data; determining positional and rotational errors from the calibration data; and modifying the position of the image area based on the errors.

The method may further comprise: labeling the sample with multiple indicators that respond to light of different wavelengths; choosing a filter pair for a selected wavelength; imaging the sample with a single monochromatic detector through the filters to produce a component scan; repeating the component scans for each of the wavelengths; and combining the component scans to produce a multi-spectral image. For each of the component scans, actual velocities and positions of the sample may be measured.

The method may further comprise: labeling the sample with multiple indicators that respond to light of different wavelengths; and simultaneously scanning the sample with multiple monochromatic detectors. The method may further comprise: labeling the sample with multiple indicators that respond to light of different wavelengths; and simultaneously scanning the sample with a single monochromatic detector masked with a color mask.

### BRIEF DESCRIPTION OF THE DRAWINGS

FIG. 1 is a diagram of an imaging system for producing an image of a microarray.

FIG. 2 shows an image-sensing chip in a CCD camera of the imaging system.

FIG. 3 shows TDI imaging operations performed by the image-sensing chip.

FIG. 4 shows a result of a TDI scan.

FIG. 5 shows a comparison between a standard scan versus a TDI scan of a fluorescent microarray sample.

FIG. 6 is a multicolor (RGB) mask used for multi-spectral imaging.

### DETAILED DESCRIPTION

FIG. 1 shows an example of an imaging system 5 using a CCD camera 38 to capture images of biological specimens. In the example, high content material, such as a microarray 32 extending over a relatively large area (up to 2-½ inches square) is accurately scanned with high resolution. An objective lens 30, with high resolution and high light collection efficiency characteristics, is used to detect the data in successive small portions (panels) of the microarray 32 present on a substrate 34. An example of such a lens is a Nikon 4× objective with a 0.2 NA.

Illumination for each panel, typically 1/10 inch (2.5 mm) square in size, which can, however, vary, is provided by a conventional white light (broad spectrum) source 36. The light (illumination) is directed obliquely to the array as shown in FIG. 1. This eliminates direct reflection of the illumination off the slide, although it is not necessary to the invention. The light from source 36 is applied to a filter 37 and then past a photosensor 44. Photosensor 44 is used to measure the total amount of illumination delivered to the small target area 33 of the microarray 32 during each exposure of the CCD camera 38.

Excitation filter 37 is one of a plurality of filters held in a filter wheel by which a number of different excitation wavelengths can be chosen under software control. In the embodiment shown, the filter wheel may be easily changed; each wheel holds four separate filters. To minimize cross-talk between filter sets, the current embodiment uses dual filters in series to produce an additive extinction effect. The illumination is provided through a fiber optic cable, which results in a highly consistent pattern of illumination.

Illumination of the array results in fluorescence from the biological specimens in area 33 which is then collected by objective lens 30. The fluorescence data is directed through lens 30, then through an emission filter 35, and then to the CCD camera 38, which detects an image of the array.

Emission filter 35, like filter 37, is one of a plurality of filters held in a filter wheel. As with the illumination filter, emission filter 35 may be selected through software control. In the embodiment shown, the emission filter wheel is easily changeable and may hold up to four emission filter sets, with each filter set comprising a pair of identical filters in series, for reduction of cross-talk and reflections.

The light travels from its source 36, through filter 37 and photosensor 44 to the specimens. Fluorescent emissions are collected by the objective lens 30 and passed through filter 35, on their way to the CCD camera 38. Such an optical system is generally conventional and therefore not discussed in detail. The general configuration of such systems, with the exception of oblique illumination, is present in fluorescence microscopes, such as available from Olympus and Nikon, or the assignee of the present invention.

The CCD camera 38 scans the microarray 32 to obtain image panels 42 in successive scanning. The image panels 42 may be joined together by processor 47, based on illumination information from the photosensor 44, to form a complete final image. In the final image, all the panels 42 have the same intensity. A digital microscopy technique for combining the image panels 42 and producing a uniform response across the image has been disclosed in a co-pending U.S. patent application Ser. No. 09/289,799, which is owned by the assignee of the present invention and is incorporated herein by reference.

In an arrangement of the present invention, the imaging system 5 performs Time-Delay Integration (TDI) to capture images of the microarray 32 in the form of image strips. An image strip may cover the same imaged area as the combined image of the panels 42 in the direction of the scan. However, an image strip scanned with TDI generally has enhanced signal-to-noise ratio (SNR) and superior image quality. With TDI, each pixel in the image strip is continuously imaged and integrated over time to form a final image. As a result, TDI allows for longer exposure time per pixel for a given total image collection time.

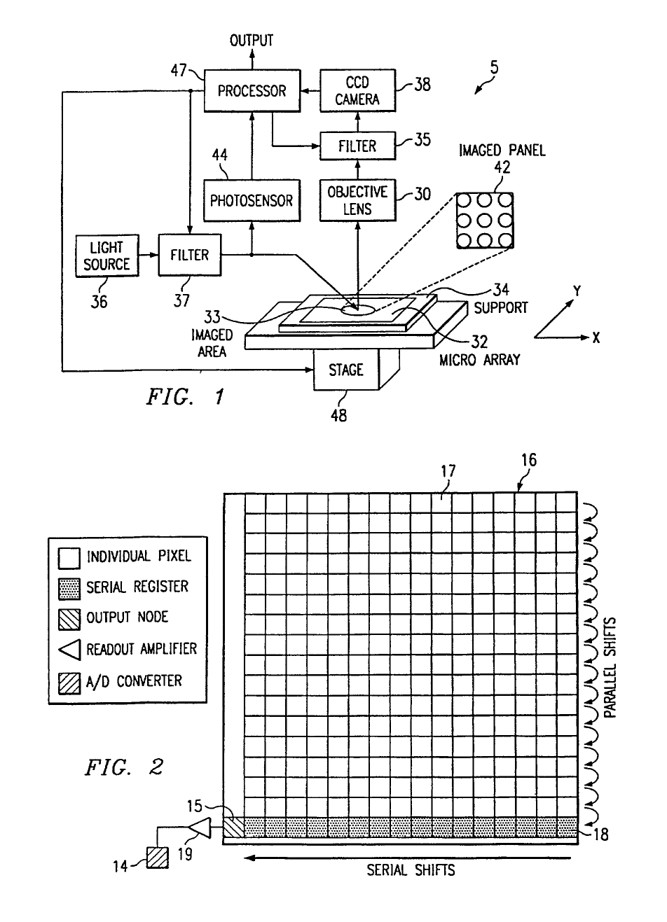

FIG. 2 shows an example of an image-sensing chip 16 of the CCD camera 38 for performing the TDI scanning. A plurality of photosites (charge-coupled wells) 17, arranged in rows and columns, are located on the surface of the chip 16. The photosites 17 convert the microarray's fluorescent emissions into electrons. Subsequently, the CCD camera 38 performs a series of parallel shifts to move the electrons down the columns of the chip 16. When the electrons reach the bottom row of the chip 16, the electrons are shifted off the chip 16 onto a row of serial registers 18. The serial registers 18 then shift the electrons serially into a readout amplifier 19 through an output node 15. Based on electrical charges of the electrons, the readout amplifier 19 creates a series of voltages that is digitized by the A/D converter 14 to form pixels of a digital image.

In an approach of the TDI scanning, the movement of the specimens relative to the camera 38 may be synchronized with the parallel shifts of the electrons. As a result, the same portion of image tracks down the chip 16 as the corresponding object on the specimens passes down the chip. The object is therefore continuous imaged throughout a period of effective exposure time, which is the time it takes for the entire chip 16 to be read by the camera 38.

TDI may be used in the imaging of objects where signal intensity is limited, such as in fluorescence imaging. To accommodate the limited light intensity coming from a fluorescent sample, the exposure time per pixel may be adjusted by changing the scan rate and the readout speed of the CCD camera 38.

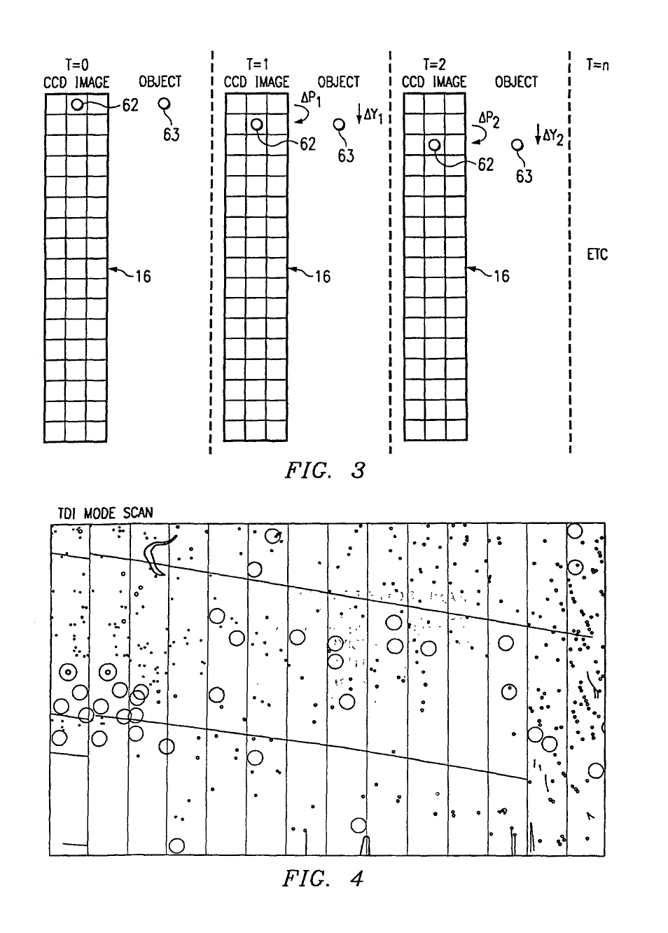

FIG. 3 shows a series of the synchronous movements at time T=0, 1, 2. A given location on the specimens is marked as an object 63. At T=0, a pixel image 62 of the object is captured by the image-sensing chip 16. At T=1, the pixel image 62 is shifted, in parallel with all other pixel images in the same row, to the second row with velocity □P₁/(T₁-T₀). The object 63 is also moved in the same direction of the parallel shift with velocity □Y₁/(T₁-T₀). Similarly, at T=2, the pixel image 62 is again shifted to the third row with velocity □P₂/(T₂-T₁), and the object 63 is also moved in the same direction of the parallel shift with velocity □Y₂/(T₂-T₁). The object 63 is moved in synchronous motion with the parallel shifts if the velocities of the pixel image 62 and the object 63 are the same. If, additionally, the velocity of the parallel shifts (Vₚ) and the velocity of the object movement (Vᵣ) are constant, the scanning operation as shown is called the “Analog TDI,” as contrasted with the “Digital TDI” discussed below.

In certain situations where the light intensity is so low as to require long exposure time, the scan speed of the camera 38 may be reduced to accommodate the long exposure. In some cases, the scan speed may be reduced to so slow as to become non-constant. The non-constant TDI scanning is called the “Digital TDI.”

In the digital TDI, an object on the sample is incrementally positioned to synchronize with the camera readout speed. The object is first moved one camera row equivalent and held there for exposure. After the exposure, the object is then moved to the next camera row for further exposure. If the object is moved by a stage, the stage movement starts and stops with each row shift in the camera 38. This process is repeated until the imaging of the sample is completed. In this way, the digital TDI scanning provides high degree of synchronization and yields excellent resolution and registration between wavelengths. Long exposure time is also accommodated.

The movement of the specimens relative to the camera 38 may be performed by moving the substrate 34 and the microarray 32. The movement may be controlled by a precise moving system or a stage 48. It is also possible, however, that the image system 5 is moved by a stage, with the substrate 34 and the microarray 32 remaining stationary.

With respect to staging accuracy, in this application, the position of each successive portion of the array is known to an accuracy of approximately one pixel, repeatable to a fraction of a pixel. A very precise staging apparatus is shown in U.S. Pat. No. 5,812,310, which is owned by the assignee of the present invention and incorporated herein by reference. Such a staging apparatus can easily meet the requirements of the present invention.

The CCD camera 38 may collect the image of the microarray 32 in multiple strips of images. After completing one strip, the imaged area on the sample is moved horizontally to allow a new strip to be acquired by the camera 38. The strips are then assembled into a montage to create a single, final image. The strips can be joined together to form a final image with minimal or no mathematical processing to achieve alignment. It is not necessary to in any way smooth or align the data between adjacent strips, or to use computation techniques to string or connect the images together based on particular features of adjacent strips. The complete array thus can be constructed purely on the recorded position of the stage at each collection point, providing coordinate points for each strip are known.

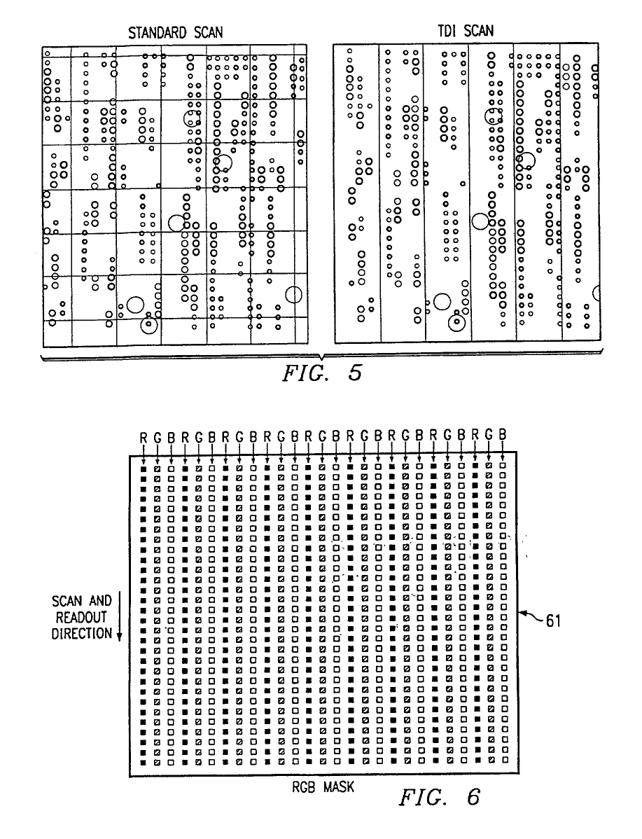

FIG. 4 and FIG. 5 show examples of TDI scanning results. In both examples, the effective exposure time is 0.4 second. Moreover, the strips or panels are joined together without flat-field calibration, panel connection, or panel flattening. That is, the final images are formed without calibrating the illumination and collection efficiencies across the field. In FIG. 4, a TDI scan of a dirty blank slide is shown. Each vertical band indicates the location of an individual strip. In FIG. 5, two imaging results of a fluorescent microarray sample are shown. The image on the left is a “standard scan,” which is obtained by successively imaging individual panels and then stitching together the imaged panels. The image on the right is a TDI scan, which is formed by successively imaging individual strips and then joining together the imaged strips. Comparing the two images, the borders of individual panels are visible in the standard scan while only the vertical bands are visible in the TDI scan.

The TDI scanning may be further simplified by using a CCD camera with a single, wide detector, capable of collecting an entire image in a single strip. When the wide detector is used, the final image is captured on a single strip and no further assembly is necessary.

The TDI scanning generally requires high staging accuracy. However, in some cases, the x, y axes of the stage 48 are not exactly parallel with the pixel rows and columns in the CCD camera 38. As a result, a rotation angle may exist between the stage 48 and the camera 38. Additionally, a positional error may be introduced when the staging area is moved in either the x or y direction. A number of factors causing misalignments between the coordinates of the stage 48 and the camera 38 have been described in U.S. Patent Application No. 60/262,000, owned by the assignee of the present invention and incorporated herein by reference.

The above incorporated application describes in detail a process for measuring and correcting rotational and positional errors in stage systems. The same correction process may be applied to TDI scans. A brief description of the correction process is presented as follows. First, coordinate calibration data is optically determined. Based on the calibration data, the alignment between the stage 48 and the camera 38 is established and the rotational and positional errors are determined. Then the process creates a solution model, based on which the movement of the stage 48 is adjusted. As a result of the adjustment, the rotational and positional errors in each imaged strip may be compensated for, and the coordinate position of the strip may be determined to a high accuracy.

The TDI scanning may be applied to monochromatic or multi-spectral imaging. When applied to multi-spectral imaging, such as a biological sample labeled with multiple spectrally separated indicators, at least two approaches may be taken, which are: sequential scanning and simultaneous scanning.

In the sequential scanning, the CCD camera 38 uses a single monochromatic detector. The imaging system 5 applies appropriate emission/excitation filter pairs 35, 37 to select multiple wavelength components. To construct a single, multiple wavelength image, the imaging system 5 scans the sample in one or more strips, changes the filters 35, 37 using a filter wheel or other appropriate means, and then scans the same sample with the new filters. The scanning is repeated for any wavelengths that are selected. Finally, the complete image is formed by combining the results of the sequential component scans.

One challenge in the sequential scanning is the registration of scans when the exposure time used for one wavelength differs from the exposure time used for another. If the component scans are not registered properly, chromatic shift may occur in the portions of the image that are derived from the component scans. To prevent the chromatic shift, positional information, such as measurements of actual velocities and positions of the sample, is obtained for each component scan. Once the information is obtained, precision motion control may be applied to synchronize the sample movement with the TDI scan.

In the simultaneous scanning, multi-spectral images may be obtained by simultaneously applying multiple CCD detectors, each with its own spectral response. The multiple detectors may simultaneously collect a multiple-wavelength image in a single scan. Such a scan may also be accomplished, alternatively, with a single CCD detector that has a specially designed multicolor mask 61 as shown in FIG. 6. The RGB mask 61 as shown has multiple color bands aligned with the scan direction. The mask 61 thus enables a single CCD detector to capture multi-spectral images in a single scan.

1. A method for imaging biological specimens using an imaging chip having rows and columns, the method comprising:
capturing a pixel image of an object on the specimens;
shifting the pixel image in the columnar direction of the imaging chip;
moving the object in synchronous motion with the pixel image; and
reading out voltage values from the bottom row of the imaging chip until a plurality of the specimens are imaged.

2. The method of claim 1, wherein voltage values are read out from the bottom row of the imaging chip until all of the specimens are imaged.

3. The method of claim 1, wherein the biological specimens are immobilized on a microarray.

4. The method of claim 1, wherein the biological specimen comprises a nucleic acid or a polypeptide.

5. The method of claim 1 further comprising
digitizing the voltage values to produce a digital image strip.

6. The method of claim 5 further comprising
imaging other strips by changing an imaged area on the specimens; and
joining together all the strips to form a final image.

7. The method of claim 5 wherein the digital image strip is a final image captured by a single wide optical detector.

8. The method of claim 1 further comprising adjusting exposure time of the image pixel by adjusting read out speed of the imaging chip.

9. The method of claim 1 further comprising adjusting exposure time of the image pixel by adjusting scan rate of the imaging chip.

10. The method of claim 1 wherein the object is moved at a constant speed.

11. The method of claim 1 wherein the object is held for exposure and is moved, one row at a time, down the imaging chip at the end of the exposure.

12. The method of claim 1 further comprising
measuring calibration data;
determining positional and rotational errors from the calibration data; and
modifying the position of an image area based on the errors.

13. The method of claim 1 further comprising
labeling the specimens with multiple indicators that respond to light of different wavelengths;
choosing a filter pair for a selected wavelength;
imaging the specimens with a single monochromatic detector through the filters to produce a component scan;
repeating the component scans for each of the wavelengths; and
combining the component scans to produce a multi-spectral image.

14. The method of claim 13 further comprising
measuring actual velocities and positions of the specimens for each of the component scans.

15. The method of claim 1 further comprising:
labeling the specimens with multiple indicators that respond to light of different wavelengths; and
simultaneously scanning the specimens with multiple monochromatic detectors.

16. The method of claim 1 further comprising:
labeling the specimens with multiple indicators that respond to light of different wavelengths; and
simultaneously scanning the specimens with a single monochromatic detector masked with a color mask.

17. A method for imaging a sample using an imaging device, the method comprising:
moving the position of an image area on the sample along one dimension of the device;
imaging a spot on the image area continuously until the imaged spot is moved out of the detection range of the device; and
adjusting the speed of the movement for adequate exposure time.

18. The method of claim 17 wherein the sample comprises a fluorescently labeled biological sample.

19. The method of claim 17 wherein the sample comprises a microarray.

20. The method of claim 17, wherein the sample comprises a plurality of nucleic acids or polypeptides immobilized to a surface.

21. The method of claim 17 wherein the imaging device is a CCD camera with columns and rows.

22. The method of claim 21 wherein the image area is moved along the columnar dimension of the CCD camera.

23. The method of claim 21 wherein the spot is held for exposure and is moved, one row at a time, down the CCD camera at the end of the exposure.

24. The method of claim 17 further comprising adjusting the exposure time of the image area by adjusting read out speed of the imaging device.

25. The method of claim 17 further comprising adjusting the exposure time of the image area by adjusting scan rate of the imaging device.

26. The method of claim 17 further comprising
measuring calibration data;
determining positional and rotational errors from the calibration data; and
modifying the position of the image area based on the errors.

27. The method of claim 17 further comprising
labeling the sample with multiple indicators that respond to light of different wavelengths;
choosing a filter pair for a selected wavelength;
imaging the sample with a single monochromatic detector through the filters to produce a component scan;
repeating the component scans for each of the wavelengths; and
combining the component scans to produce a multi-spectral image.

28. The method of claim 17 further comprising
measuring actual velocities and positions of the sample for each of the component scans.

29. The method of claim 17 further comprising:
labeling the sample with multiple indicators that respond to light of different wavelengths; and
simultaneously scanning the sample with multiple monochromatic detectors.

30. The method of claim 17 further comprising:
labeling the sample with multiple indicators that respond to light of different wavelengths; and
simultaneously scanning the sample with a single monochromatic detector masked with a color mask.
